(19) United States
(12) Patent Application Publication
(10) Pub. No.: US 2024/0188135 A1
(43) Pub. Date: Jun. 6, 2024

(54) CHANNEL BACKOFF IN A WIRELESS NETWORK

(71) Applicant: NXP USA, Inc., Austin, TX (US)

(72) Inventor: Liwen Chu, San Ramon, CA (US)

(21) Appl. No.: 18/531,573

(22) Filed: Dec. 6, 2023

Related U.S. Application Data
(60) Provisional application No. 63/386,319, filed on Dec. 6, 2022.
(60) Provisional application No. 63/507,510, filed on Jun. 12, 2023.

(51) Int. Cl. H04W 74/08

(52) U.S. Cl. CPC H04W 74/0816

(57) ABSTRACT

Embodiments of a method and apparatus for wireless communications are disclosed. In an embodiment, a device includes a controller configured to select backoff channels of subchannels of a Basic Service Set (BSS) operating channel and a wireless transceiver configured to announce to a second device the backoff channels of the subchannels of the BSS operating channel for use in communicating between the device and the second device, where the subchannels include a primary subchannel and at least one non-primary subchannel.

### CROSS-REFERENCE TO RELATED APPLICATIONS

This application is entitled to the benefit of U.S. Provisional Patent Application Ser. No. 63/386,319, filed on Dec. 6, 2022, and U.S. Provisional Patent Application Ser. No. 63/507,510, filed on Jun. 12, 2023, the contents of each of which are incorporated by reference herein.

### BACKGROUND

Wireless communications devices, e.g., access points (APs) or non-AP devices can transmit various types of information using different transmission techniques. For example, various applications, such as, Internet of Things (IOT) applications can conduct wireless local area network (WLAN) communications, for example, based on Institute of Electrical and Electronics Engineers (IEEE) 802.11 family of standards (e.g., Wi-Fi standards). Some applications, for example, video teleconferencing, streaming entertainment, high definition (HD) video surveillance applications, outdoor video sharing applications, etc., require relatively high system throughput. Back-off techniques can be used to reduce or avoid communication collisions and/or improve communications throughputs in a wireless network (e.g., a WLAN), allowing for more data to be transmitted.

### SUMMARY

Embodiments of a method and apparatus for wireless communications are disclosed. In an embodiment, a device includes a controller configured to select backoff channels of subchannels of a Basic Service Set (BSS) operating channel and a wireless transceiver configured to announce to a second device the backoff channels of the subchannels of the BSS operating channel for use in communicating between the device and the second device, where the subchannels include a primary subchannel and at least one non-primary subchannel. Other embodiments are also disclosed.

In an embodiment, the controller is further configured to decide whether the device and the second device have medium synchronization information.

In an embodiment, the backoff channels include 20 Megahertz (MHz) backoff channels.

In an embodiment, the subchannels include 80 MHz subchannels or 160 MHz subchannels, and the BSS operating channel includes a 160 MHz BSS operating channel or a 320 MHz BSS operating channel.

In an embodiment, the wireless transceiver is further configured to transmit a data unit to the second device in a backoff channel of the non-primary subchannel.

In an embodiment, the wireless transceiver is further configured to announce a backoff channel of a subchannel covered by a physical layer protocol data unit (PPDU) as a dummy primary channel for resource unit (RU) coding to the second device when a bandwidth (BW) of a PPDU transmitted between the device and the second device is wider than a BW of a subchannel of the BSS operating channel.

In an embodiment, the wireless transceiver is further configured to perform backoff through one of the backoff channels when the primary subchannel is busy because of a neighbor BSS's transmission opportunity (TXOP).

In an embodiment, the wireless transceiver is further configured to announce in a management frame whether backoff on a non-primary subchannel is allowed in a BSS.

In an embodiment, the controller is further configured to allocate different priorities to the subchannels of the BSS operating channel.

In an embodiment, the wireless transceiver is further configured to announce the different priorities of the subchannels of the BSS operating channel.

In an embodiment, the wireless transceiver is further configured to start a transmit opportunity for data unit exchanges with the second device after a backoff counter reaches zero.

In an embodiment, the wireless transceiver is further configured to announce using a management frame, where the management frame is one of a Beacon Frame, a Probe Response Frame, and an Association Response Frame.

In an embodiment, the wireless transceiver is further configured to send a message to the second device to park in a non-primary subchannel that includes a backoff channel.

In an embodiment, the device includes a wireless access point (AP), and the second device includes a non-AP station (STA) device.

In an embodiment, the device is compatible with an Institute of Electrical and Electronics Engineers (IEEE) 802.11 protocol.

In an embodiment, the device is a component of a multi-link device (MLD).

In an embodiment, a wireless AP includes a controller configured to select 20 MHz backoff channels of subchannels of a Basic Service Set (BSS) operating channel and a wireless transceiver configured to announce to a non-AP STA device the backoff channels of the subchannels of the BSS operating channel for use in communicating between the wireless AP and the non-AP STA device, where the subchannels include a primary subchannel and at least one non-primary subchannel.

In an embodiment, the wireless transceiver is further configured to perform backoff through one of the backoff channels when the primary subchannel is busy because of a neighbor BSS's transmission opportunity (TXOP).

In an embodiment, the controller is further configured to allocate different priorities to the subchannels of the BSS operating channel.

In an embodiment, a method for wireless communications involves selecting backoff channels of subchannels of a BSS operating channel and announcing the backoff channels of the subchannels of the BSS operating channel for use in wireless communications, where the subchannels include a primary subchannel and at least one non-primary subchannel.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a Basic Service Set (BSS) operating channel primary and backoff diagram in accordance with an embodiment of the invention.

FIG. 3 depicts a secondary channel switch in accordance with an embodiment of the invention.

FIG. 4 depicts a secondary channel switch in accordance with an embodiment of the invention.

FIG. 5 depicts a single protection scheme of a transmission opportunity (TXOP) in accordance with an embodiment of the invention.

FIG. 6 depicts a multiple protection scheme of a TXOP in accordance with an embodiment of the invention.

FIG. 7 depicts a multiple protection scheme of a TXOP in accordance with an embodiment of the invention.

FIG. 8 depicts a BSS operating channel primary and backoff diagram with priority information in accordance with an embodiment of the invention

FIG. 9 depicts a BSS operating channel primary and backoff diagram with priority information in accordance with an embodiment of the invention.

FIG. 10 depicts a BSS operating channel primary and backoff diagram with priority information in accordance with an embodiment of the invention.

FIG. 11 depicts an example channel backoff process that corresponds to the BSS operating channel primary and backoff diagram with priority information depicted in FIG. 10 in accordance with an embodiment of the invention.

FIG. 12 depicts an example channel backoff process that corresponds to the BSS operating channel primary and backoff diagram with priority information depicted in FIG. 10 in accordance with an embodiment of the invention.

FIG. 13 depicts a wireless device in accordance with an embodiment of the invention.

FIG. 14 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

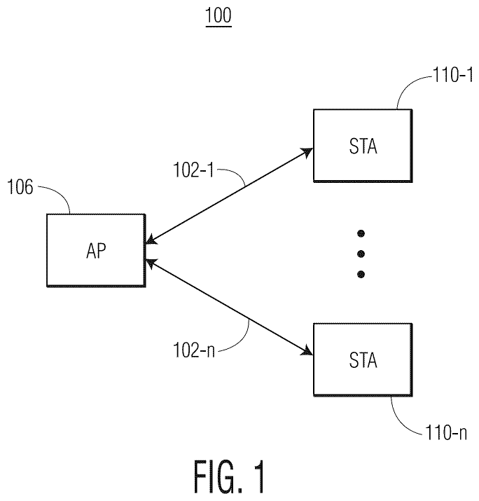

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with one STA, multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications links. In some embodiments, the wireless communications system 100 described with reference to FIG. 1 involves multi-link communications and the AP and the STA communicate through multiple communications links. Furthermore, the techniques described herein may also be applicable to each link of a multi-link communications system.

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communications device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

An Access Point (AP) can allocate its BSS operating channel to multiple subchannels (e.g., each 80 Megahertz (MHz) subchannel of a 160 MHz BSS channel, each 80 MHz subchannel of a 320 MHz BSS channel or each 160 MHz subchannel of a 320 MHz BSS channel), where each subchannel includes one backoff 20 MHz channel. The subchannel with the primary 20 MHz channel as the special backoff 20 MHz channel is the primary subchannel and a subchannel without the primary 20 MHz channel is a non-primary subchannel. In some implementations, the 20 MHz backoff channel of each of the different multiple subchannels is not punctured. If the primary subchannel is busy because of a transmission opportunity (TXOP) of a neighbor BSS, the AP and its associated STAs switch to a non-primary subchannel and do frame exchanges on the non-primary subchannel after the backoff on the backoff 20 MHz channel of the non-primary 20 MHz channel. At the end of the neighbor BSS's TXOP, the AP and its associated STAs switch back to the primary subchannel to do the frame exchanges after the backoff procedure in the primary 20 MHz channel. Such a switch from one subchannel to another subchannel is a dynamic subchannel switch.

Multiple 20 Megahertz (MHz) channels can be the backoff 20 MHz channels. One restriction may be that in each basic service set (BSS) operating subchannel (e.g., every 80 MHz channel (BSS subchannel) of 320 MHz BSS operating channel, a backoff 20 MHz channel is defined). An AP/STA with multiple backoff 20 MHz channels can perform simultaneous backoff on the multiple 20 MHz backoff channels. Another option may be that at any time the backoff is performed in one 20 MHz backoff channel. A further restriction may be that when the primary 20 Mhz channel is busy, the other 20 MHz backoff channel is used for the backoff. In an implementation, when each 80 MHz channel has one backoff channel, a multi-user (MU) physical layer protocol data unit (PPDU) in a secondary 160 MHz channel needs to indicate a dummy primary 20 MHz channel that is used to define Resource Units (RUS) in the MU PPDU in the secondary 160 MHz channel. In an implementation, when a multi-user (MU) physical layer protocol data unit (PPDU) covers one subchannel, the backoff channel of the subchannel is the dummy primary 20 MHz channel that is used to define Resource Units (RUS) in the MU PPDU.

In an example, when a non-AP STA (STA1) of a non-simultaneously transmit and receive (STR) (NSTR) link pair or an Enhanced Multilink Single-Radio (EMLSR) link pair performs frame exchange in one link and another STA (STA2) of the NSTR link pair or the EMLSR link pair cannot perform Clear Channel Assessment (CCA), STA2 loses the medium synchronization. After the condition(s) that make(s) STA2's CCA failing disappear(s), STA2 starts a MediumSyncDelay timer. Before the MediumSyncDelay timer becomes 0, STA2 can perform the backoff per energy detect (ED) level (−72 dbm if announced by the AP multi-link device (MLD) or −62 dbm as default value) if STA1 also finishes its frame exchanges with the associated AP. After the backoff counter becomes 0, STA2 can transmit a Request to Send (RTS) message to solicit a Clear to Send (CTS) message. This CTS soliciting is based on the assumption that the APs of affiliated AP MLD are all in STR links.

Some examples of backoff on non-primary 20 MHz channel is described as follows. No all STAs/APs that can perform backoff on non-primary 20 MHz channel can do the CCA simultaneously on multiple 20 MHz channels. A STA/AP that cannot perform simultaneous CCA on multiple 20 MHz channels may lose the medium synchronization of a BSS subchannel after the frame exchanges in other BSS subchannel(s). A STA/AP that that can perform backoff on non-primary 20 MHz channel may lose the medium synchronization when it transmits a long PPDU (e.g., longer than 72 microseconds (μs)). In a BSS subchannel, both the AP/STA that transmit RTS (request to send) and the peer device that is the recipient of the RTS may lose the medium synchronization. When Subchannel Selective Transmission (SST) is enabled, in a BSS subchannel, both the AP and STA may have the medium synchronization information, i.e., the network allocation vector (NAV) timer and PHY CCA are the current medium usage state.

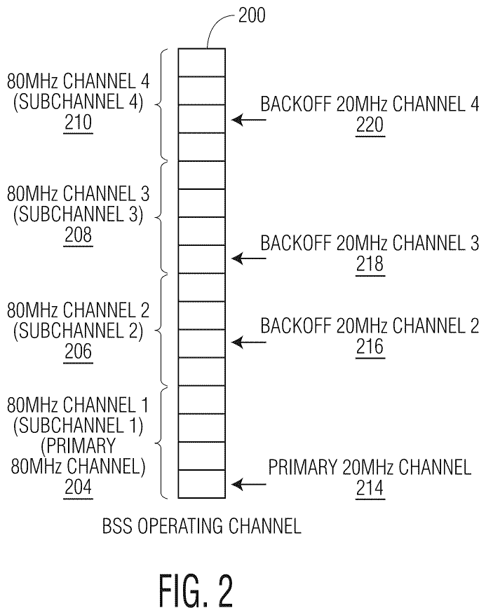

FIG. 2 depicts a BSS operating channel primary and backoff diagram 200 in accordance with an embodiment of the invention. In the BSS operating channel primary and backoff diagram depicted in FIG. 2, a 320 MHz BSS operating channel includes a first subchannel (referred to as subchannel 1) 204 of 80 MHz that contains the primary 20 MHz channel 214, a second subchannel (referred to as subchannel 2) 206 of 80 MHz that contains the backoff 20 MHz channel 2 216, a third subchannel (referred to as subchannel 3) 208 of 80 MHz that contains the backoff 20 MHz channel 3 218, and a fourth subchannel (referred to as subchannel 4) 210 of 80 MHz that contains the backoff 20 MHz channel 4 220. Although the depicted BSS operating channel primary and backoff diagram 200 is shown in FIG. 2 with certain primary and backoff channels, other embodiments may include different combinations of primary and backoff channels.

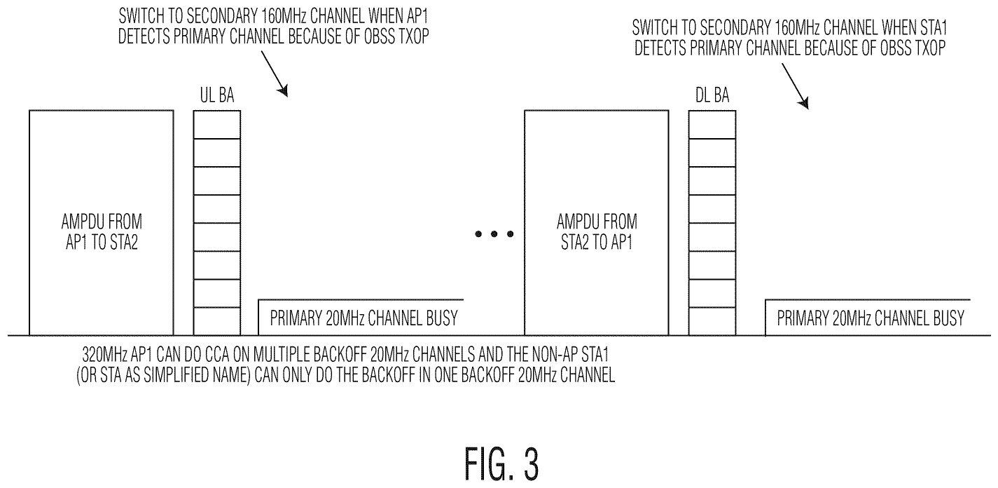

FIG. 3 depicts a secondary channel switch in accordance with an embodiment of the invention. In the embodiment depicted in FIG. 3, API may switch to secondary 160 MHz channel when API detects primary channel because of Overlapping Basic Service Set (OBSS) TXOP. STA1 may switch to secondary 160 MHz channel when STA1 detects primary channel because of OBSS TXOP. In some embodiments, 320 MHz API can perform CCA on multiple backoff 20 MHz channels and the non-AP STA1 (or STA as simplified name) can only perform the backoff in one backoff 20 MHz channel.

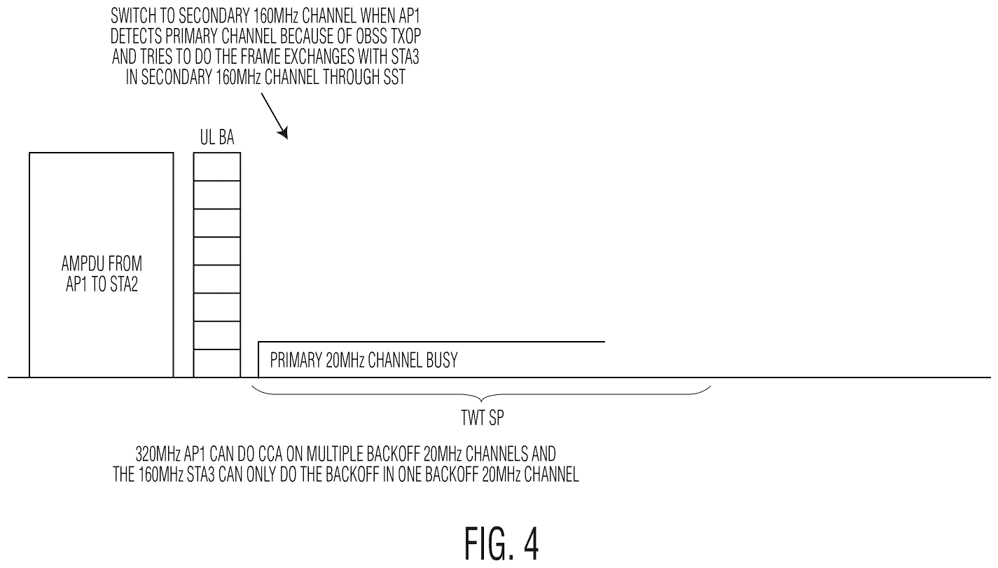

FIG. 4 depicts a secondary channel switch in accordance with an embodiment of the invention. In the embodiment depicted in FIG. 3, API may switch to secondary 160 MHz channel when API detects primary channel because of OBSS TXOP and tries to do the frame exchanges with STA3 in secondary 160 MHz channel through SST. In some embodiments, 320 MHz API can perform CCA on multiple backoff 20 MHz channels and the 160 MHz STA3 can only perform the backoff in one backoff 20 MHz channel.

Some examples of PPDU with PPDU bandwidth (BW) more than the BSS subchannel BW are described as follows.

In a first option, each BSS subchannel can have a backoff 20 MHz channel. In some embodiments, for each PPDU BW that is wider than a BSS subchannel BW, an AP announces the backoff 20 MHz channel of a BSS subchannel covered by the PPDU as the dummy primary 20 MHz for the RU coding, e.g., the different priorities are given to the different backoff 20 MHz channels and the backoff 20 MHz channel with the highest priority being covered by the PPDU is the dummy primary 20 MHz channel. In a first example, in secondary 160 MHz channel where BSS subchannel is 80 MHz channel, the backoff 20 MHz channel of lowest 80 MHz channel in secondary 160 MHz channel is the dummy 20 MHz channel for the RU coding. In a second example, in secondary 320 MHz channel where BSS subchannel is 80 MHz channel, the backoff 20 MHz channel of highest 80 MHz channel in secondary 160 MHz channel is the dummy 20 MHz channel for the RU coding. In a third example, in 240 MHz channel where BSS subchannel is 80 MHz channel and the primary 20 MHz channel is not included, the dummy 20 MHz channel of 160 MHz channel is the dummy 20 MHz channel for the RU coding. In a fourth example, in 240 MHz channel where BSS subchannel is 80 MHz channel and the primary 20 MHZ channel is not included, the dummy 20 MHz channel of 160 MHz channel is the primary 20 MHz channel for the RU coding since 240 MHz channel is 320 MHz channel with 80 MHz channel being punctured (the PPDU indicate 320 MHz BW with 80 MHz being punctured). In one embodiment, if a PPDU BW covers the primary 20 MHz channel, the primary 20 MHz channel is the reference for the RU coding.

In a second option, the secondary 80 MHz channel has one backoff 20 MHz channel. The secondary 160 MHz channel has one backoff 20 MHz channel.

Some examples of medium access synchronization are described as follows.

In a first option, when the primary 20 MHz is busy because of the neighbor BSS's TXOP, the backoff through the other backoff 20 MHz channel is done. In some embodiments, the TXOP that is acquired through a backoff on a non-primary backoff 20 MHz channel ends no later than the end of the primary 20 MHz channel's TXOP. In some embodiments, when both sides lose the medium synchronization, transmitting RTS after backoff through ED level is not allowed. For example, the transmitting of the other frames is not allowed by IEEE 802.11be.

In a second option, when the primary 20 MHz is busy because of the neighbor BSS's TXOP, the backoff through the other backoff 20 MHz channel is done. In some embodiments, the TXOP that is acquired through a backoff on a non-primary backoff 20 MHz channel ends no later than the end of the primary 20 MHz channel's TXOP. In some embodiments, when both sides lose the medium synchronization, transmitting RTS after backoff through ED level is allowed. In some embodiments, after receiving the RTS, if the NAV timer has 0 value and the PHY CCA per ED level indicates the medium is idle Point coordination function (PCF) Interframe Space (PIFS) before the RTS reception, the CTS can be transmitted (or is idle Short Interframe Space (SIFS) after the RTS reception in another embodiment). In one embodiment, the initiating control frame can be Buffer Status Report Poll (BSRP) Trigger, Bandwidth Query Report Poll (BQRP) Trigger, MU-RTS, or another control frame instead of RTS frame.

In a third option, it is up to the AP/STA to decide which backoff 20 MHz channel is selected for the backoff. In some embodiments, when both sides lose the medium synchronization, transmitting RTS after backoff through ED level is not allowed. For example, the transmitting of the other frames is not allowed by IEEE 802.11be.

In a fourth option, it is up to the AP/STA to decide which backoff 20 MHz channel is selected for the backoff. In some embodiments, when both sides lose the medium synchronization, transmitting RTS after backoff through ED level is allowed. In some embodiments, after receiving the RTS, if the NAV timer has 0 value and the PHY CCA per ED level indicates the medium is idle PIFS before the RTS reception, the CTS can be transmitted.

Some examples of announcement of the non-primary channel backoff usage by the neighbor BSS are described as follows. With such announcement by an AP, the STAs associated with AP can adjust their behavior for better coexistence with the neighbor BSS, e.g., to avoid the medium synchronization loss of the neighbor BSS when switching back from the secondary TXOP to the primary channel backoff in the neighbor BSS. In some embodiments, an AP announces in the management frame (e.g., Beacon, Probe Response) whether the backoff on nonprimary 20 MHz channel is allowed in its BSS. In some embodiments, a STA notifies its associated AP whether it detects that the neighbor BSS can do the backoff on nonprimary 20 MHz channel. In some embodiments, an AP announces whether there is any neighbor BSS that allows backoff on nonprimary 20 MHz channel per AP's reception of neighbor BSS and/or associated STA's notification. In some embodiments, when the AP announces that the neighbor BSS can do the backoff on nonprimary 20 MHz channel, the AP and the STAs associated with the AP use multiple protection to protect the TXOP. In some embodiments, the Duration/ID field indicates the end of the TXOP.

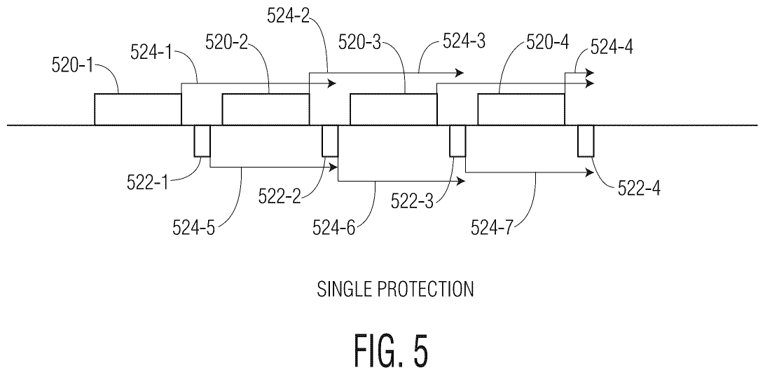

FIG. 5 depicts a single protection scheme of a TXOP in accordance with an embodiment of the invention. In the embodiment depicted in FIG. 5, a first wireless device (e.g., a wireless AP) may transmit PPDU packets or packet fragments 520-1, 520-2, 520-3, 520-4 to a second wireless device (e.g., a wireless STA) in a TXOP, which may respond with acknowledgment (ACK) 522-1, 522-2, 522-3, 522-4. In the TXOP, the single protection is used, with the TXOP protection as indicated by arrows 524-1, 524-2, 524-3, 524-4, 524-5, 524-6, 524-7. With such protection, when the neighbor BSS enables secondary channel backoff, the neighbor BSS switch back to the primary channel in the middle of the TXOP since the neighbor BSS assumes that the TXOP ends per the Duration value of 524-1. More collision will happen.

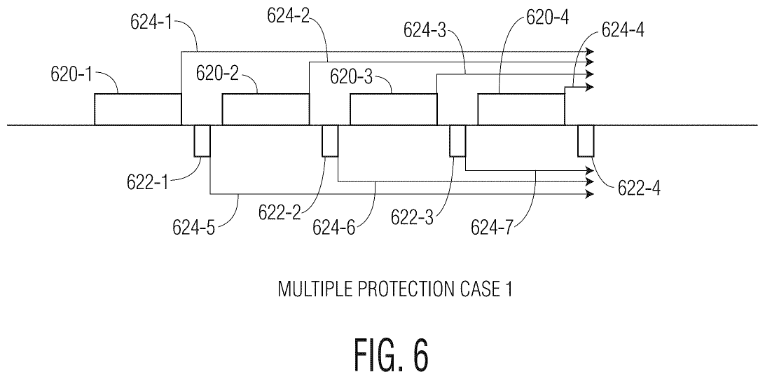

FIG. 6 depicts a multiple protection scheme of a TXOP in accordance with an embodiment of the invention. In the embodiment depicted in FIG. 6, a first wireless device (e.g., a wireless AP) may transmit PPDU packets or packet fragments 620-1, 620-2, 620-3, 620-4 to a second wireless device (e.g., a wireless STA) in a TXOP, which may respond with acknowledgment (ACK) 622-1, 622-2, 622-3, 622-4. In the TXOP, the multiple protection is used to set the Duration/ID field of the MAC header with the TXOP protection as indicated by arrows 624-1, 624-2, 624-3, 624-4, 624-5, 624-6, 624-7. In the multiple protection, the Duration/ID field indicates the end of the TXOP or the time before the end of the TXOP. With such protection, when the neighbor BSS enables secondary channel backoff, the neighbor BSS switch back to the primary channel at the end of the TXOP. Less collision will happen.

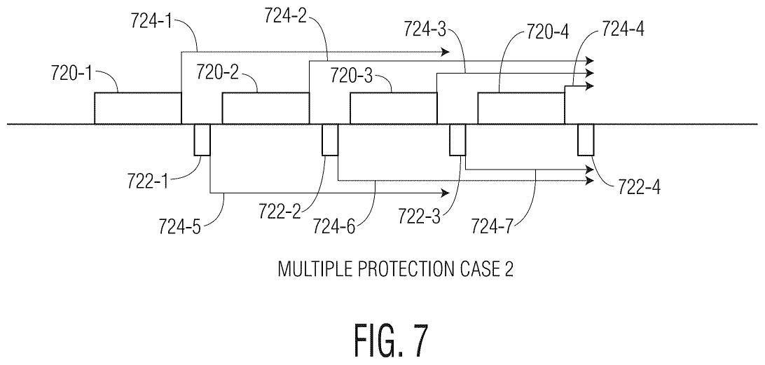

FIG. 7 depicts a multiple protection scheme of a TXOP in accordance with an embodiment of the invention. In the embodiment depicted in FIG. 7, a first wireless device (e.g., a wireless AP) may transmit PPDU packets or packet fragments 720-1, 720-2, 720-3, 720-4 to a second wireless device (e.g., a wireless STA) in a TXOP, which may respond with acknowledgment (ACK) 722-1, 722-2, 722-3, 722-4. The multiple protection is used to set the Duration/ID field of the MAC header with the TXOP protection as indicated by arrows 724-1, 724-2, 724-3, 724-4, 724-5, 724-6, 724-7. In multiple protection, the Duration/ID field indicates the time before the end of the TXOP. With such protection, when the neighbor BSS enables secondary channel backoff, the neighbor BSS switch back to the primary channel in the middle of the TXOP since the neighbor BSS assumes that the TXOP ends per the Duration value of 724-1. More collision will happen. Based on such description, the TXOP protection per FIG. 6 is the appropriate mechanism when neighbor BSS enables secondary channel backoff.

Examples of priorities of multiple subchannels are described as follows. In some embodiments, when an AP has multiple subchannels, the priorities are given to the subchannels for the subchannel switch when the primary subchannel that has primary 20 MHz channel is busy. The primary subchannel may have the highest priority. In a first option, the AP announces the subchannels and the priorities of each subchannel. In a second option, the priorities of the subchannels are decided by the location of the subchannels, whether a subchannel is firstly combined with the primary subchannel without puncture and whether a subchannel is near the primary subchannel.

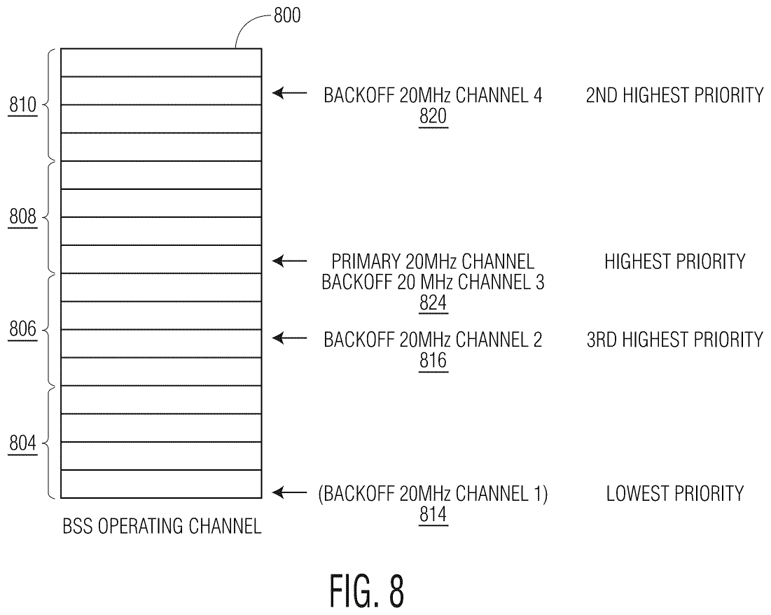

FIG. 8 depicts a BSS operating channel primary and backoff diagram 800 with priority information in accordance with an embodiment of the invention. In the BSS operating channel primary and backoff diagram depicted in FIG. 8, in 320 MHz BSS operating BW with 4 80 MHz subchannels 804, 806, 808, 810, the primary subchannel (the subchannel that covers primary 20 MHz channel (also the backoff 20 MHz channel 3) 824) 808 has the highest priority, the subchannel 810 that is part of the primary 160 MHz with the backoff 20 MHz channel 4 820 has second highest priority, the subchannel 806 in secondary 160 MHz channel with the backoff 20 MHz channel 2 816 that is near the primary 80 MHz channel has third priority, and another subchannel 804 in secondary 160 MHz channel with the backoff 20 MHz channel 1 814 has lowest priority. Although the depicted BSS operating channel primary and backoff diagram 200 is shown in FIG. 2 with certain primary and backoff channels, other embodiments may include different combinations of primary and backoff channels.

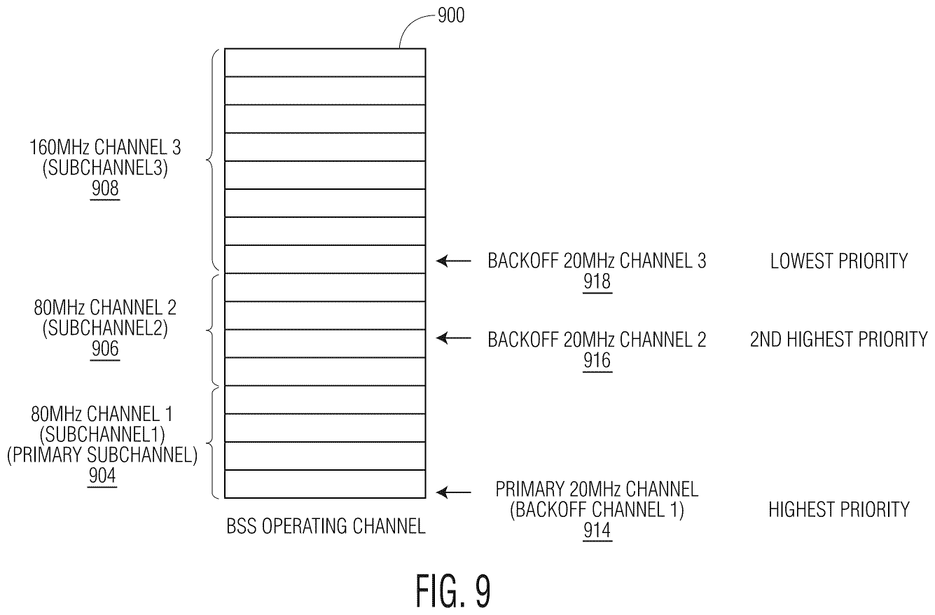

FIG. 9 depicts a BSS operating channel primary and backoff diagram 900 with priority information in accordance with an embodiment of the invention. In the BSS operating channel primary and backoff diagram depicted in FIG. 9, in 320 MHz BSS operating BW with 3 subchannels, i.e., the primary 80 MHz as primary subchannel (subchannel1) 904 with the primary 20 MHz channel (also the backoff 20 MHz channel 1) 914, secondary 80 MHz as the second subchannel (subchannel2) 906 with the backoff 20 MHz channel 2 916, secondary 160 MHz as the third subchannel (subchannel3) 908 with the backoff 20 MHz channel 3 918. The primary subchannel (the subchannel that covers primary 20 MHz channel) has the highest priority, the subchannel that is part of the primary 160 MHz has second highest priority, and the subchannel that is secondary 160 MHz channel has lowest priority.

Some examples of RU index of MU PPDU under multiple subchannels are described as follows. In some embodiments, for the same RU in a downlink/uplink (DL/UL) multi-user (MU) PPDU, the different STAs may figure out the different RU index when the following happen, the MU PPDU covers multiple subchannels, the different STAs or AP and STA assume the 20 MHz channels in the different subchannels as the backoff 20 MHz channels for RU index acquiring, and/or the clarification of the RU index of a RU is required. In a first option, based on the backoff 20 MHz channel being used for the backoff and single subchannel being used for the MU PPDU transmission if the backoff 20 MHz channel is not the primary 20 MHz channel. In a second option, based on the backoff 20 MHz channel with the highest priority covered by the PPDU BW even if the backoff 20 MHz channel is punctured. In a third option, if the backoff 20 MHz channel is not the primary 20 MHz channel, the BSS BW is always used when figuring out the RU index of the MU PPDU even if the MU PPDU BW is narrower than the BSS operating BW.

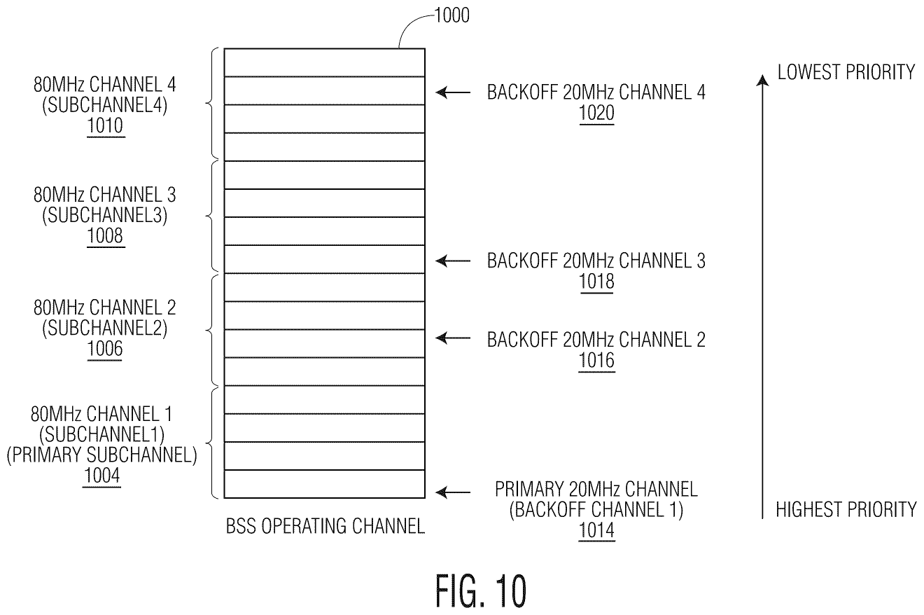

FIG. 10 depicts a BSS operating channel primary and backoff diagram 1000 with priority information in accordance with an embodiment of the invention. In the BSS operating channel primary and backoff diagram depicted in FIG. 10, the first subchannel (referred to as subchannel 1) 1004 of 80 MHz that contains the primary 20 MHz channel 1014 has the highest priority, the second subchannel (referred to as subchannel 2) 1006 of 80 MHz that contains the backoff 20 MHz channel 2 1016 has the lower priority, the third subchannel (referred to as subchannel 3) 1008 of 80 MHz that contains the backoff 20 MHz channel 3 1018 has the lower priority, and the fourth subchannel (referred to as subchannel 4) 1010 of 80 MHz that contains the backoff 20 MHz channel 4 1020 has the lowest priority.

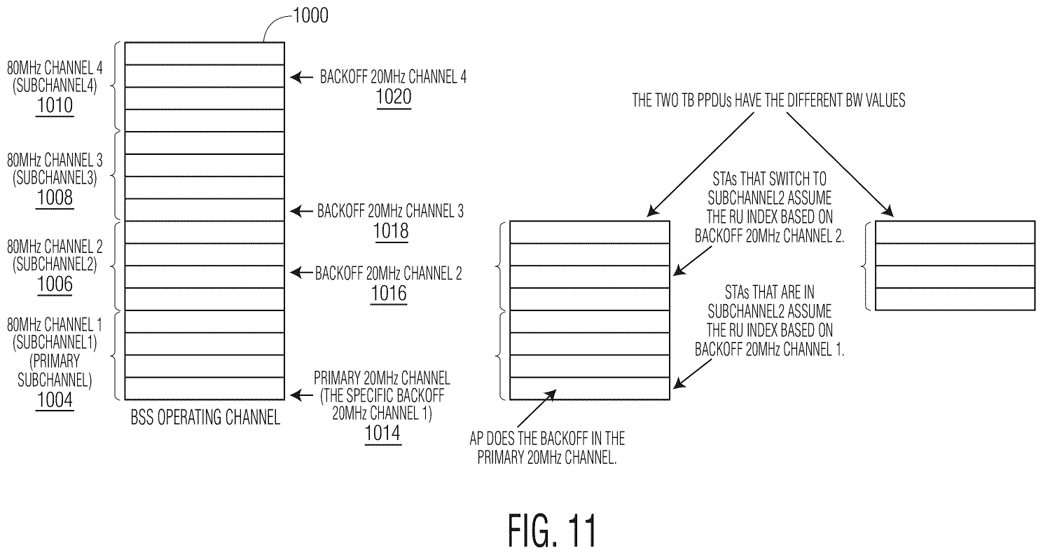

FIG. 11 depicts an example channel backoff process that corresponds to the BSS operating channel primary and backoff diagram 1000 with priority information depicted in FIG. 10 in accordance with an embodiment of the invention. As depicted in FIG. 11, an AP detects the idle subchannel 1 and performs the backoff through subchannel 1 in the primary 20 MHz channel. After the backoff, the AP transmits a trigger frame to solicit the 160 MHz trigger-based (TB) PPDU since the subchannel 3 is busy. When the AP detects primary 20 MHz busy, the AP switches to subchannel 2 to do the backoff. After the backoff, the AP transmits a trigger frame to solicit the 80 MHz trigger-based (TB) PPDU since the subchannel 3 is busy. Through the method of using highest priority backoff 20 MHz channel covered by the 160 MHz TB PPDU for the RU index, the STAs that are in subchannel1 assume the RU index based on backoff 20 MHz channel 1. The STAs that switch to subchannel2 assume the RU index based on backoff 20 MHz channel 1. STAs that are in subchannel2 assume the RU index based on Backoff 20 MHz channel 1. Through the method of using the only backoff 20 MHz channel covered by 80 MHz TB PPDU for the RU index, the STAs that are in subchannel1 will not decode the Trigger frame. The STAs that switch to subchannel2 assume the RU index based on backoff 20 MHz channel 2.

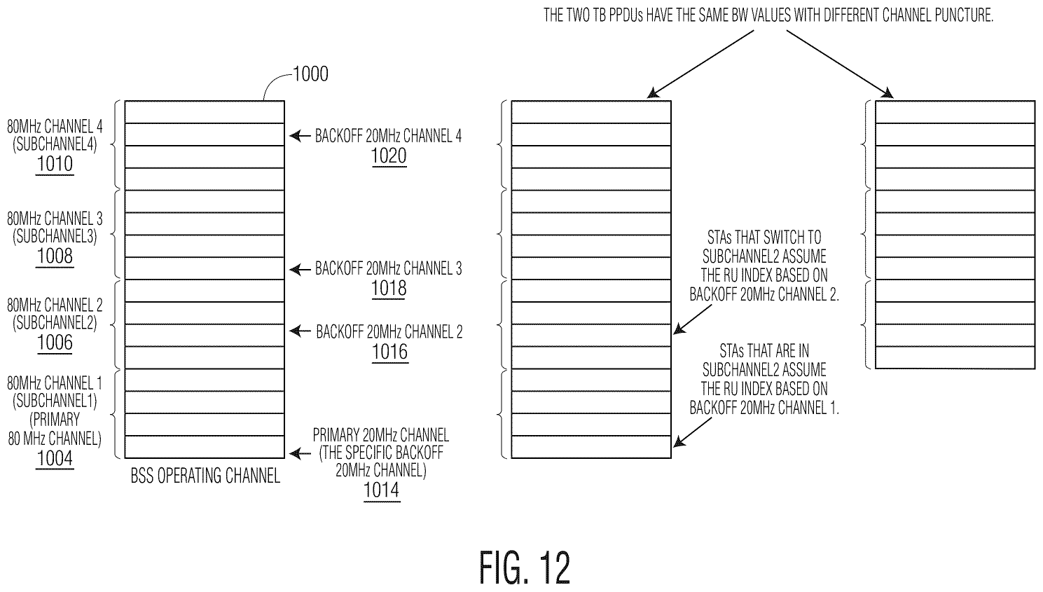

FIG. 12 depicts an example channel backoff process that corresponds to the BSS operating channel primary and backoff diagram 1000 with priority information depicted in FIG. 10 in accordance with an embodiment of the invention. As depicted in FIG. 12, an AP detects the idle subchannel 1 and does the backoff through subchannel 1. Some STAs detect busy subchannel 1 and some STAs detect idle subchannel 1. The AP transmits the Trigger frame to solicit the 320 MHz TB PPDU. The STAs that are in subchannel1 assume the RU index based on backoff 20 MHz channel 1. The STAs that switch to subchannel2 assume the RU index based on backoff 20 MHz channel 1 since the 320 MHz TB PPDU covers the primary 20 MHz channel. When an AP detects the busy subchannel 1 and switch to the second subchannel. Some STAs detect busy subchannel 1 and some STAs detect idle subchannel 1. After the backoff procedure, the AP transmits the Trigger frame to solicit the 240 MHz TB PPDU (320 MHz TB PPDU with primary 80 MHz being punctured). Although primary 80 MHz channel is punctured, the 320 MHz BW covers the primary 20 MHz channel. The STAs that are in subchannel1 assume the RU index based on backoff 20 MHz channel 1.

Some examples of backoff in various subchannels are described as follows. For example, whether AP and STA perform the backoff on non-primary subchannel can be implemented in various options. In a first option, when switching to a subchannel that does not include primary 20 MHz channel, only the AP can do the backoff. The associated STAs are not allowed to perform the backoff when switching to a subchannel that does not include primary 20 MHz channel. In a second option, when switching to a subchannel that does not include primary 20 MHz channel, the AP can perform the backoff. The AP will announce whether the associated STAs can perform the backoff when switching to a subchannel that does not include primary 20 MHz channel. In a third option, when switching to a subchannel that does not include primary 20 MHz channel, both the AP and the associated STAs can perform the backoff.

Some examples of frame exchange through backoff in non-primary subchannel are described as follows. For example, when to enable the frame exchanges after switching to a non-primary subchannel can be implemented in various options. In a first option, if a STA or an AP backoff counter in a non-primary subchannel becomes 0 and the time starting from the STA/AP switching to the non-primary channel is not less than the maximal transition delay of the peer devices (AP or STAs) that can do the secondary subchannel switch, the STA/AP can initiate the frame exchanges with the AP/STA(s) respectively. If a STA or an AP backoff counter in a non-primary subchannel becomes 0 and the time starting from the STA/AP switching to the non-primary channel is less than the maximal transition delay of the peer devices (AP or STAs) that can do the secondary subchannel switch, the STA/AP needs to start another backoff. In a second option, if a STA or an AP backoff counter in a non-primary subchannel becomes 0 and the time starting from the STA/AP switching to the non-primary channel is not less than the transition delay of the selected TXOP responder(s) (AP or STAs), the STA/AP can initiate the frame exchanges with the AP/STA(s) respectively. If a STA or an AP backoff counter in a non-primary subchannel becomes 0 and the time starting from the STA/AP switching to the non-primary channel is less than the transition delay of the selected TXOP responder(s) (AP or STAs), the STA/AP needs to start another backoff. In a third option, if a STA or an AP backoff counter in a non-primary subchannel becomes 0, the STA/AP can initiate the frame exchanges with the AP/STA(s) respectively.

Some examples of frame exchange through backoff in primary subchannel are described as follows. For example, when to enable the frame exchanges after switching to a primary subchannel can be implemented in various options. In a first option, if a STA or an AP backoff counter in the primary subchannel becomes 0 and the time starting from the STA/AP switching to the primary channel is not less than the maximal transition delay of the peer devices (AP or STAs) that can do the secondary subchannel switch, the STA/AP can initiate the frame exchanges with the AP/STA(s) respectively. If a STA or an AP backoff counter in a primary subchannel becomes 0 and the time starting from the STA/AP switching to the primary channel is less than the maximal transition delay of the peer devices (AP or STAs) that can do the secondary subchannel switch, the STA/AP needs to start another backoff. In a second option, if a STA or an AP backoff counter in a primary subchannel becomes 0 and the time starting from the STA/AP switching to the primary channel is not less than the transition delay of the selected TXOP responder(s) (AP or STAs), the STA/AP can initiate the frame exchanges with the AP/STA(s) respectively. If a STA or an AP backoff counter in a primary subchannel becomes 0 and the time starting from the STA/AP switching to the primary channel is less than the transition delay of the selected TXOP responder(s) (AP or STAs), the STA/AP needs to start another backoff. In a third option, if a STA or an AP backoff counter in a primary subchannel becomes 0, the STA/AP can initiate the frame exchanges with the AP/STA(s) respectively.

Some examples of channel switch under multiple non-primary subchannels are described as follows. For example, when to perform the channel switch from one non-primary channel to another non-primary channel can be implemented in various options. In a first option, if in one of the non-primary subchannels an AP or STA detects medium busy, the AP/STA needs to switch the next non-primary subchannel with lower priority until the non-primary subchannel with the lowest priority. In a second option, if in one of the non-primary subchannels an AP or STA detects medium busy, it is up to the AP/STA to decide whether switch the next non-primary subchannel with lower priority until the non-primary subchannel with the lowest priority. In a third option, a TXOP duration threshold is defined so that when the medium of a non-primary subchannel is busy through 20 MHz channel's CCA of the nonprimary subchannel and the TXOP duration is longer than the TXOP duration threshold, the AP and the STAs switch to another non-primary channel.

When to perform the channel switch from the primary subchannel to another non-primary channel can be implemented in various options. In a first option, a TXOP duration threshold is defined so that when the medium is busy through the primary 20 MHz channel's CCA and the TXOP duration is longer than the TXOP duration threshold, the AP and the STAs switch to the non-primary channel.

When to perform the channel switch from a non-primary subchannel to the primary channel can be implemented in various options. In a first option, at the end of the TXOP of the primary subchannel, the AP and STAs switch back to the primary subchannel for the CCA. In a second option, at the end of the TXOP of the non-primary subchannel initiated by the AP or the associated STA of the AP, the AP and the STAs switch back to the primary subchannel for the CCA.

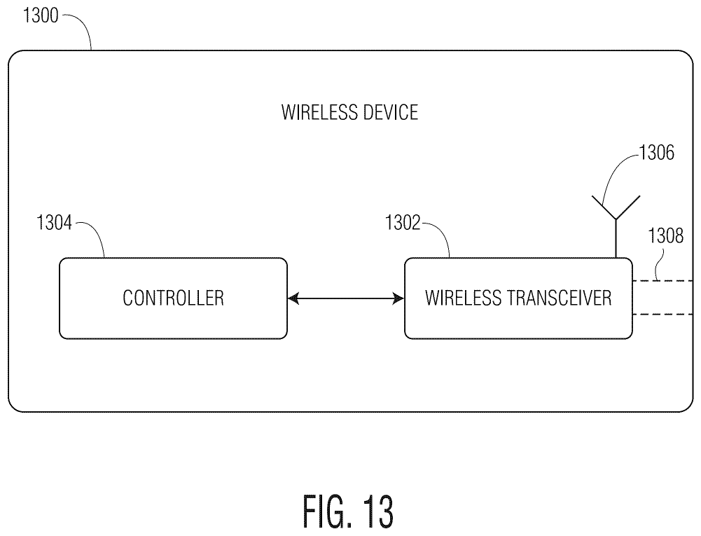

FIG. 13 depicts a wireless device 1300 in accordance with an embodiment of the invention. The wireless device 1300 can be used in the wireless communications system 100 depicted in FIG. 1. For example, the wireless device 1100 may be an embodiment of the AP 106 depicted in FIG. 1 and/or the STA 110-1, . . . , 110-n depicted in FIG. 1.

In the embodiment depicted in FIG. 13, the wireless device 1300 includes a wireless transceiver 1302, a controller 1304 operably connected to the wireless transceiver, and at least one antenna 1306 operably connected to the wireless transceiver. In some embodiments, the wireless device 1300 may include at least one optional network port 1308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1300 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the controller 1304 is configured to select backoff channels of subchannels of a Basic Service Set (BSS) operating channel and the wireless transceiver 1302 is configured to announce to a second wireless device the backoff channels of the subchannels of the BSS operating channel for use in communicating between the wireless device 1300 and the second wireless device, where the subchannels include a primary subchannel and at least one non-primary subchannel. In some embodiments, the controller is further configured to decide whether the wireless device 1300 and the second wireless device have medium synchronization information. In some embodiments, the backoff channels include 20 Megahertz (MHz) backoff channels. In some embodiments, the subchannels include 80 MHz subchannels or 160 MHz subchannels, and the BSS operating channel includes a 160 MHz BSS operating channel or a 320 MHz BSS operating channel. In some embodiments, the wireless transceiver is further configured to transmit a data unit to the second wireless device in a backoff channel of the non-primary subchannel. In some embodiments, the wireless transceiver is further configured to announce a backoff channel of a subchannel covered by a physical layer protocol data unit (PPDU) as a dummy primary channel for resource unit (RU) coding to the second wireless device when a bandwidth (BW) of a physical layer protocol data unit (PPDU) transmitted between the wireless device and the second wireless device is wider than a BW of a subchannel of the BSS operating channel. In some embodiments, the wireless transceiver is further configured to perform backoff through one of the backoff channels when the primary subchannel is busy because of a neighbor BSS's transmission opportunity (TXOP). In some embodiments, the wireless transceiver is further configured to announce in a management frame whether backoff on a non-primary subchannel is allowed in a BSS. In some embodiments, the controller is further configured to allocate different priorities to the subchannels of the BSS operating channel. In some embodiments, the wireless transceiver is further configured to announce the different priorities of the subchannels of the BSS operating channel. In some embodiments, the wireless transceiver is further configured to start a transmit opportunity for data unit exchanges with the second wireless device after a backoff counter reaches zero. In some embodiments, the wireless transceiver is further configured to announce using a management frame, where the management frame is one of a Beacon Frame, a Probe Response Frame, and an Association Response Frame. In some embodiments, the wireless transceiver is further configured to send a message to the second wireless device to park in a non-primary subchannel that includes a backoff channel. In some embodiments, the wireless device is a wireless access point (AP), and the second wireless device is a non-AP station (STA) device. In some embodiments, the wireless device is compatible with an Institute of Electrical and Electronics Engineers (IEEE) 802.11 protocol. In some embodiments, the wireless device is a component of a multi-link device (MLD).

In some embodiments, the wireless device 1300 is a wireless AP that includes the controller 1304 configured to select 20 MHz backoff channels of subchannels of a BSS operating channel and the wireless transceiver 1304 configured to announce to a non-AP STA device the backoff channels of the subchannels of the BSS operating channel for use in communicating between the wireless AP and the non-AP STA device, where the subchannels include a primary subchannel and at least one non-primary subchannel. In some embodiments, the wireless transceiver is further configured to perform backoff through one of the backoff channels when the primary subchannel is busy because of a neighbor BSS's TXOP. In some embodiments, the controller is further configured to allocate different priorities to the subchannels of the BSS operating channel. In some embodiments, the controller is further configured to decide whether the wireless AP and the non-AP STA device have medium synchronization information. In some embodiments, the subchannels include 80 MHz subchannels or 160 MHz subchannels, and the BSS operating channel includes a 160 MHz BSS operating channel or a 320 MHz BSS operating channel. In some embodiments, the wireless transceiver is further configured to transmit a data unit to the non-AP STA device in a backoff channel of the non-primary subchannel. In some embodiments, the wireless transceiver is further configured to announce a backoff channel of a subchannel covered by a PPDU as a dummy primary channel for RU coding to the non-AP STA device when a bandwidth (BW) of a PPDU transmitted between the wireless AP and the non-AP STA device is wider than a BW of a subchannel of the BSS operating channel. In some embodiments, the wireless transceiver is further configured to announce in a management frame whether backoff on a non-primary subchannel is allowed in a BSS. In some embodiments, the wireless transceiver is further configured to announce the different priorities of the subchannels of the BSS operating channel. In some embodiments, the wireless transceiver is further configured to start a transmit opportunity for data unit exchanges with the non-AP STA device after a backoff counter reaches zero. In some embodiments, the wireless transceiver is further configured to announce using a management frame, where the management frame is one of a Beacon Frame, a Probe Response Frame, and an Association Response Frame. In some embodiments, the wireless transceiver is further configured to send a message to the non-AP STA device to park in a non-primary subchannel that includes a backoff channel. In some embodiments, the wireless AP is compatible with an IEEE 802.11 protocol. In some embodiments, the wireless AP is a component of a multi-link device (MLD).

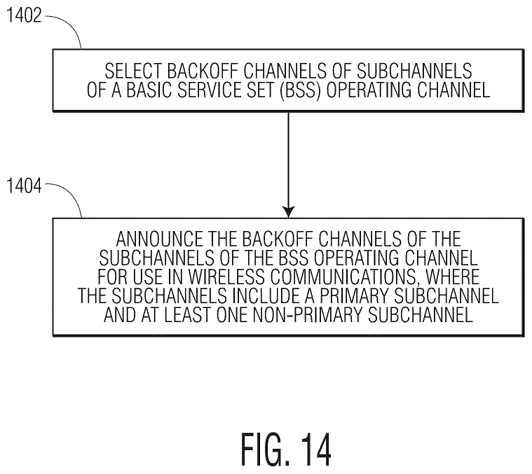

FIG. 14 is a process flow diagram of a method for wireless communications in accordance with an embodiment of the invention. At block 1402, backoff channels of subchannels of a Basic Service Set (BSS) operating channel are selected. At block 1404, the backoff channels of the subchannels of the BSS operating channel for use in wireless communications are announced, where the subchannels include a primary subchannel and at least one non-primary subchannel. In some embodiments, the backoff channels include 20 MHz backoff channels. In some embodiments, the subchannels include 80 MHz subchannels or 160 MHz subchannels, and the BSS operating channel includes a 160 MHz BSS operating channel or a 320 MHz BSS operating channel. In some embodiments, a data unit is transmitted in a backoff channel of the non-primary subchannel. In some embodiments, a backoff channel of a subchannel covered by a physical layer protocol data unit (PPDU) as a dummy primary channel for resource unit (RU) coding is announced when a bandwidth (BW) of a physical layer protocol data unit (PPDU) is wider than a BW of a subchannel of the BSS operating channel. In some embodiments, backoff is performed through one of the backoff channels when the primary subchannel is busy because of a neighbor BSS's TXOP. In some embodiments, whether backoff on a non-primary subchannel is allowed in a BSS is announced in a management frame. In some embodiments, different priorities are allocated to the subchannels of the BSS operating channel. In some embodiments, the different priorities of the subchannels of the BSS operating channel are announced. In some embodiments, a transmit opportunity for data unit exchanges with the second wireless device is started after a backoff counter reaches zero. In some embodiments, announcement is made using a management frame, where the management frame is one of a Beacon Frame, a Probe Response Frame, and an Association Response Frame. In some embodiments, a message is sent to a second wireless device to park in a non-primary subchannel that includes a backoff channel.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A device comprising:
a controller configured to select a plurality of backoff channels of a plurality of subchannels of a Basic Service Set (BSS) operating channel; and
a wireless transceiver configured to announce to a second device the backoff channels of the subchannels of the BSS operating channel for use in communicating between the device and the second device, wherein the subchannels include a primary subchannel and at least one non-primary subchannel.

2. The device of claim 1, wherein the controller is further configured to decide whether the device and the second device have medium synchronization information.

3. The device of claim 1, wherein the backoff channels comprise a plurality of 20 Megahertz (MHz) backoff channels.

4. The device of claim 3, wherein the subchannels comprise a plurality of 80 MHz subchannels or 160 MHz subchannels, and wherein the BSS operating channel comprises a 160 MHz BSS operating channel or a 320 MHz BSS operating channel.

5. The device of claim 1, wherein the wireless transceiver is further configured to transmit a data unit to the second device in a backoff channel of the non-primary subchannel.

6. The device of claim 1, wherein the wireless transceiver is further configured to announce a backoff channel of a subchannel covered by a physical layer protocol data unit (PPDU) as a dummy primary channel for resource unit (RU) coding to the second device when a bandwidth (BW) of a PPDU transmitted between the device and the second device is wider than a BW of a subchannel of the BSS operating channel.

7. The device of claim 1, wherein the wireless transceiver is further configured to perform backoff through one of the backoff channels when the primary subchannel is busy because of a neighbor BSS's transmission opportunity (TXOP).

8. The device of claim 1, wherein the wireless transceiver is further configured to announce in a management frame whether backoff on a non-primary subchannel is allowed in a BSS.

9. The device of claim 1, wherein the controller is further configured to allocate different priorities to the subchannels of the BSS operating channel.

10. The device of claim 9, wherein the wireless transceiver is further configured to announce the different priorities of the subchannels of the BSS operating channel.

11. The device of claim 9, wherein the wireless transceiver is further configured to start a transmit opportunity for data unit exchanges with the second device after a backoff counter reaches zero.

12. The device of claim 1, wherein the wireless transceiver is further configured to announce using a management frame, wherein the management frame is one of a Beacon Frame, a Probe Response Frame, and an Association Response Frame.

13. The device of claim 1, wherein the wireless transceiver is further configured to send a message to the second device to park in a non-primary subchannel that includes a backoff channel.

14. The device of claim 1, wherein the device comprises a wireless access point (AP), and wherein the second device comprises a non-AP station (STA) device.

15. The device of claim 1, wherein the device is compatible with an Institute of Electrical and Electronics Engineers (IEEE) 802.11 protocol.

16. The device of claim 1, wherein the device is a component of a multi-link device (MLD).

17. A wireless access point (AP) comprising:
a controller configured to select a plurality of 20 Megahertz (MHz) backoff channels of a plurality of subchannels of a Basic Service Set (BSS) operating channel; and
a wireless transceiver configured to announce to a non-AP station (STA) device the backoff channels of the subchannels of the BSS operating channel for use in communicating between the wireless AP and the non-AP STA device, wherein the subchannels include a primary subchannel and at least one non-primary subchannel.

18. The wireless AP of claim 17, wherein the wireless transceiver is further configured to perform backoff through one of the backoff channels when the primary subchannel is busy because of a neighbor BSS's transmission opportunity (TXOP).

19. The wireless AP of claim 18, wherein the controller is further configured to allocate different priorities to the subchannels of the BSS operating channel.

20. A method for wireless communications, the method comprising:
selecting a plurality of backoff channels of a plurality of subchannels of a Basic Service Set (BSS) operating channel; and
announcing the backoff channels of the subchannels of the BSS operating channel for use in wireless communications, wherein the subchannels include a primary subchannel and at least one non-primary subchannel.
